(19) United States
(12) Patent Application Publication
(10) Pub. No.: US 2025/0139622 A1
(43) Pub. Date: May 1, 2025

(54) SYSTEMS AND METHODS FOR THROTTLED SHARING OF PERSONAL INFORMATION

(71) Applicant: JPMORGAN CHASE BANK, N.A., New York, NY (US)

(72) Inventors: Gerardo GEAN, Plano, TX (US); Raghu VUDATHU, Downingtown, PA (US)

(21) Appl. No.: 18/495,515

(22) Filed: Oct. 26, 2023

(51) Int. Cl. G06Q 20/40; G06Q 20/02; G06Q 20/42

(52) U.S. Cl. CPC G06Q 20/4014; G06Q 20/02; G06Q 20/42

(57) ABSTRACT

Systems and methods for throttled sharing of personal information are disclosed. A method for throttled sharing of personal information may include: (1) receiving, by a computer program at a trusted entity and from a customer, customer personal information; (2) receiving, by the computer program at the trusted entity and from a third party system, an identification of personal information fields required for a transaction; (3) receiving, by the computer program at the trusted entity and from the third party system, a request for personal information verification for a transaction involving the customer; (4) retrieving, by the computer program, the personal information fields required by the third party system; (5) creating, by the computer program, a payload comprising the customer personal information for the personal information fields required by the third party system; and (6) returning, by the computer program, the payload to the third party system.

### BACKGROUND OF THE INVENTION

### 1. Field of the Invention

Embodiments generally relate to systems and methods for throttled sharing of personal information.

### 2. Description of the Related Art

Customers conducting transactions with merchants are often required to provide some personal information (“PI”) to the merchant. The merchant is not always trustworthy, and may request more information than is actually needed. Further, there is a risk of the personal information being compromised. In certain cases, even if the merchant is trustworthy, when the merchant asks for information to prove the customer's identity, the current identity verification mechanisms such as driver's license, passport id, etc. reveal more information to the merchant than is needed for that particular transaction.

### SUMMARY OF THE INVENTION

Systems and methods for throttled sharing of personal information are disclosed. According to an embodiment, a method for throttled sharing of personal information may include: (1) receiving, by a computer program at a trusted entity and from a customer, customer personal information; (2) receiving, by the computer program at the trusted entity and from a third party system, an identification of personal information fields required for a transaction; (3) receiving, by the computer program at the trusted entity and from the third party system, a request for personal information verification for a transaction involving the customer; (4) retrieving, by the computer program, the personal information fields required by the third party system; (5) creating, by the computer program, a payload comprising the customer personal information for the personal information fields required by the third party system; and (6) returning, by the computer program, the payload to the third party system.

In one embodiment, the method may also include determining, by the computer program, an amount of the customer personal information to return to the third party system, wherein the payload may include the determined amount of the customer personal information.

In one embodiment, the method may also include: providing, by the computer program, the payload to the customer; and receiving, by the computer program, approval from the customer to provide the payload to the third party system. The approval may be received before the payload is provided to the third party system.

In one embodiment, the customer personal information may include a customer name, a customer address, a customer phone number, a customer date of birth, and/or customer memberships.

In one embodiment, the request for personal information verification may include an identification of a payment card for the customer.

In one embodiment, the customer personal information may be associated with the payment card.

In one embodiment, the personal information fields required comprise a subset of the customer personal information may include a customer name, a customer address, a customer phone number, a customer date of birth, and/or customer memberships.

In one embodiment, the payload may include a Boolean response.

According to another embodiment, a system may include a trusted entity executing a trusted entity computer program that may be configured to receive, from a customer, customer personal information, and a third party system that may be configured to provide the trusted entity computer program with an identification of personal information fields required for a transaction and to request personal information verification from the trusted entity computer program for a transaction involving the customer. The trusted entity computer program may be configured to retrieve the personal information fields required by the third party system in response to the request, to create a payload comprising the customer personal information for the personal information fields required by the third party system, and to return the payload to the third party system.

In one embodiment, the trusted entity computer program may be further configured to determine an amount of the customer personal information to return to the third party system, and the payload may include the determined amount of the customer personal information.

In one embodiment, the trusted entity computer program may be further configured to provide the payload to the customer, to receive approval from the customer to provide the payload to the third party system before providing the payload to the third party system.

In one embodiment, the customer personal information may include a customer name, a customer address, a customer phone number, a customer date of birth, and/or customer memberships.

In one embodiment, the request for personal information verification may include an identification of a payment card for the customer.

In one embodiment, the customer personal information may be associated with the payment card.

In one embodiment, the personal information fields required comprise a subset of the customer personal information may include a customer name, a customer address, a customer phone number, a customer date of birth, and/or customer memberships.

In one embodiment, the payload may include a Boolean response.

According to another embodiment, a non-transitory computer readable storage medium, may include instructions stored thereon, which when read and executed by one or more computer processors, cause the one or more computer processors to perform steps comprising: receiving, from a customer, customer personal information, wherein the customer personal information may include a customer name, a customer address, a customer phone number, a customer date of birth, and/or customer memberships; receiving, from a third party system, an identification of personal information fields required for a transaction; receiving, from the third party system, a request for personal information verification for a transaction involving the customer, wherein the request for personal information verification may include an identification of a payment card for the customer; retrieving the personal information fields required by the third party system; determining, by the computer program, an amount of the customer personal information to return to the third party system; creating a payload comprising the determined amount of the customer personal information for the personal information fields required by the third party system; and returning the payload to the third party system.

In one embodiment, the non-transitory computer readable storage medium may also include instructions stored thereon, which when read and executed by one or more computer processors, cause the one or more computer processors to perform steps comprising: providing the payload to the customer; and receiving approval from the customer to provide the payload to the third party system. The approval may be received before the payload is provided to the third party system.

In one embodiment, the customer personal information may be associated with the payment card.

In one embodiment, the personal information fields required comprise a subset of the customer personal information may include a customer name, a customer address, a customer phone number, a customer date of birth, and/or customer memberships.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for throttled sharing of personal information according to an embodiment;

FIGS. 2A and 2B depict a method for throttled sharing of personal information according to an embodiment;

FIG. 3 depicts an exemplary computing system for implementing aspects of the present disclosure.

### DETAILED DESCRIPTION OF PREFERRED EMBODIMENTS

Embodiments are directed to systems and methods for throttled sharing of personal information.

Embodiments may enable customers to provide real-time consent to share their personal information to a third party, such as a merchant. For example, a trusted entity, such as a financial institution, may share limited personal information with the third party. In one embodiment, the amount of personal information shared may be limited based on personal information fields that were configured during onboarding of the third party, as well as customer consent and/or approval.

In embodiments, the customer may be informed of the personal information to be shared and with whom it will be shared in the approval process. Examples of data that may be shared may include first name, last name, address, phone number, email address, date of birth, etc.

In another embodiment, instead of providing personal information, personal information verification may be provided. For example, a third party may request verification that a customer is over 21 years old. Instead of providing the customer's birthdate, the trusted entity may return a verification that the customer is over 21 years old based on the trusted entity's records.

As another example, the customer may use a token or financial instrument to verify membership at, for example, a club, lounge, gym, etc. Instead of presenting a membership card, the customer may instead present credentials to the third party, and the third party may verify membership via the financial institution. Thus, a transaction need not occur for this verification.

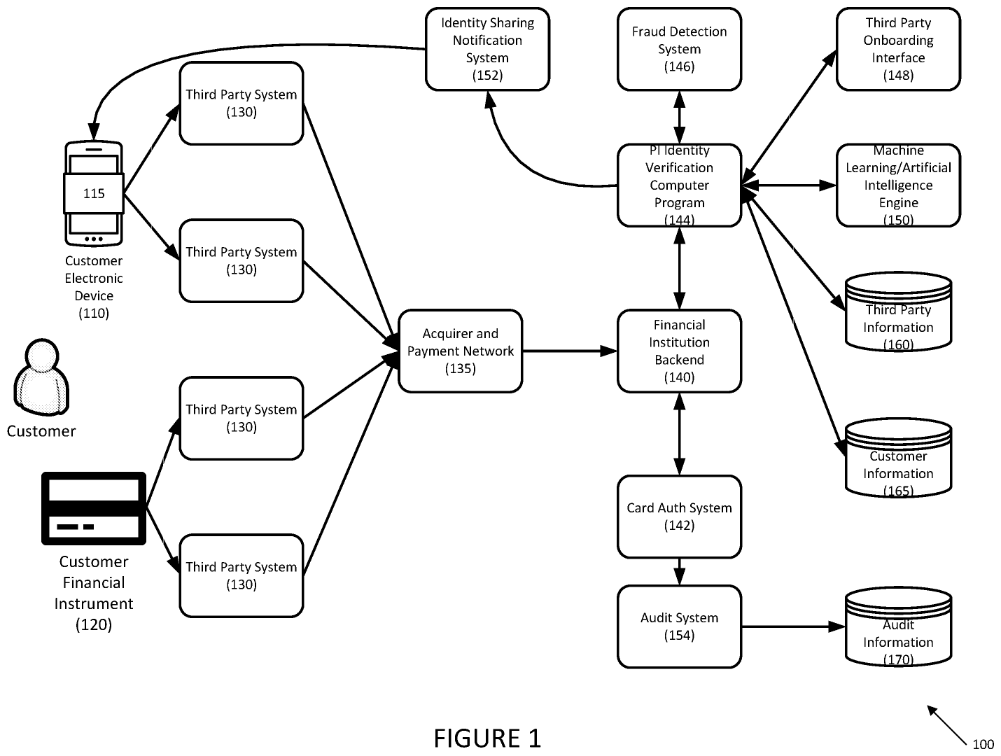

Referring to FIG. 1, a system for throttled sharing of personal information is disclosed according to an embodiment. System 100 may include a customer that may operate customer electronic device 110. Customer electronic device 110 may be provisioned with payment token 115 in a digital wallet (not shown), and may present payment token 115 to third party system 130, such as a point of sale device, an on-line checkout, etc., for a third party, such as a merchant. The customer may also present customer financial instrument 120, such as a credit card, a debit card, etc. to third party system 130.

In one embodiment, the customer may present payment token 115 or customer financial instrument 120 as part of conducting a transaction for a good or service. In another embodiment, the customer may present payment token 115 or customer financial instrument 120 as part of age verification, address verification, membership verification, status verification, etc.

Third party system 130 may communicate payment token 115 or customer financial instrument 120 to acquirer and payment network 135, which may communicate payment token 115 or customer financial instrument 120 to a trusted entity, such as a financial institution backend 140. Financial institution backend 140 may route payment token 115 or customer financial instrument 120 to card authorization system 142, which may authorize any pending transaction. It may further communicate payment token 115 or customer financial instrument 120 to personal information verification computer program 144, which may retrieve third party information from third party information database 160.

Third party information database 160 may store information from onboarded third parties. For example, third parties may provide personal information requirements to third party onboarding interface 148, such as personal information fields required by third party system 130 (e.g., minimum age requirement, membership requirements, etc.), formatting of the fields (e.g., data or a yes/no response), etc. Each third party system 130 may configure the required fields as is necessary and/or desired.

Personal information verification computer program 144 may identify the fields required by third party system 130 and the format of the field, and may access customer information in customer information database 165. Customer information database 165 may store information for customers or registered entities of the trusted entity. Examples of information may include last name, first name, address, telephone number, email address, date of birth, driver's license number, etc. Personal information verification computer program 144 may generate a payload of the required personal information and may optionally provide it to the customer for approval to share with third party system 130 for sharing approval.

In one embodiment, personal information verification computer program 144 may request approval using, for example, identify sharing notification system 152, which may request approval via email, SMS, in-app messaging, etc.

In one embodiment, identify sharing notification system 152 may also provide notification to the customer whenever personal information is shared.

If the customer does not require approval to share, personal information verification computer program 144 may share the payload with third party system 130.

In one embodiment, the customer may opt-in to sharing personal information with certain third parties, or may opt-in to sharing certain amounts of personal information without further approval. The customer may also opt-in to sharing personal information verification without further approval.

Personal information verification computer program 144 may also interface with fraud detection systems 146. If fraud detection systems 146 identify a certain risk of fraud, fraud detection systems 146 may prevent any personal information from being shared with third party systems.

Machine learning/artificial intelligence engine 150 may identify personal information fields that a third party should request.

In one embodiment, machine learning/artificial intelligence engine 150 may learn different merchants and their business domains, and may adjust the criteria to share only certain personal information with the merchants. Over time, there may not be a necessity for merchants to onboard customers to choose which personal information to share with the merchant.

Machine learning/artificial intelligence engine 150 may automatically configure or determine the amount of personal information to share to provide a seamless customer and merchant experience. Embodiments may also learn to suppress sharing certain personal information that is no longer needed by the merchant, or to add additional personal information to the response payload when the merchant needs additional personal information. All of this intelligence could reside in ML/AI system.

System 100 may further include audit system 154 and audit information database 170. Audit system 154 may identify instances of the sharing of personal information and may store those instances in audit information database 170 for later review.

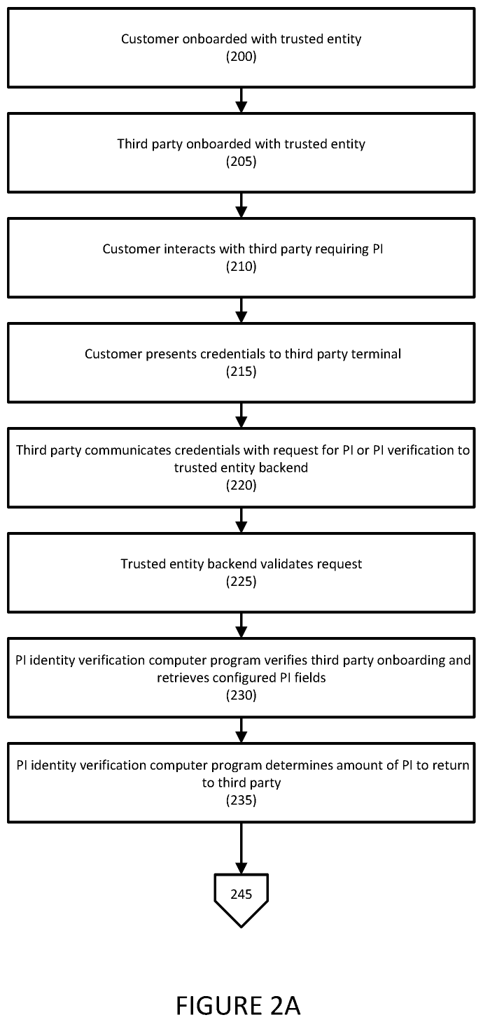

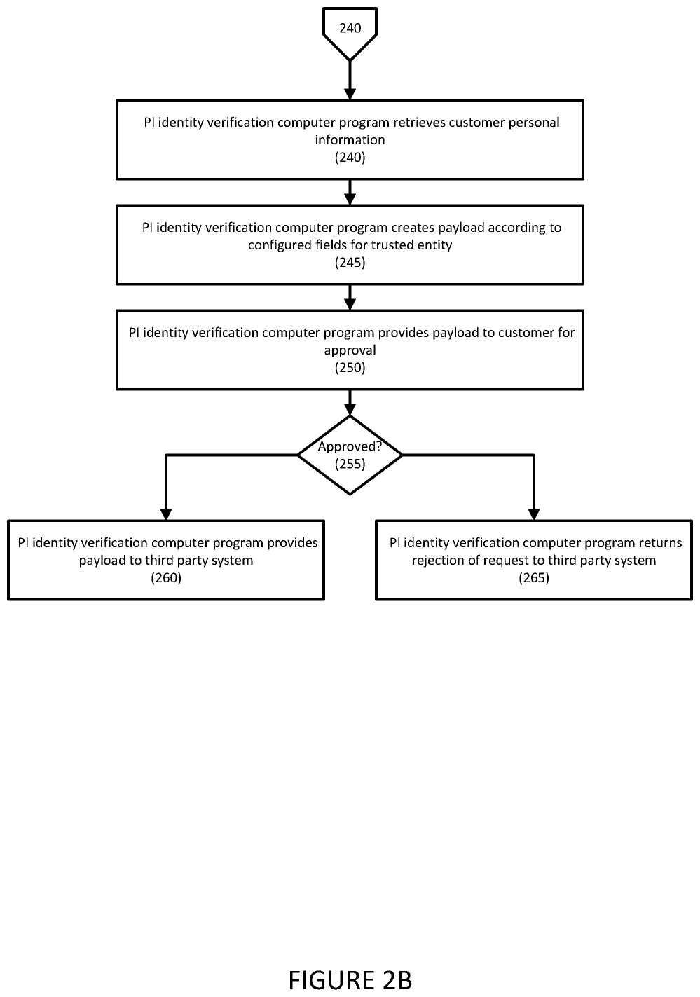

Referring to FIGS. 2A and 2B, a method for throttled sharing of personal information is disclosed according to an embodiment.

In step 200, a customer may be onboarded with a trusted entity, such as a financial institution. In one embodiment, the customer may be a customer of the trusted entity, and may have provided personal information to the trusted entity as part of the enrollment process. Examples of personal information may include the customer's name, address, date of birth, social security number, email address, etc.

In one embodiment, as part of the onboarding, the trusted entity may verify the customer personal information (e.g., as part of its Know Your Customer requirements).

The trusted entity may link or associate an identifier, such as a payment card (e.g., credit card, debit card, etc.) account number with the customer's personal information.

In step 205, one or more third parties may be onboarded with the trusted entity. In one embodiment, the third party, which may be a merchant, may identify certain PI fields that it may require to conduct a transaction or otherwise interact with the customer.

In one embodiment, the third party may not require personal information, but may only require personal information verification (e.g., that the customer is over 21 years old, the customer lives in a certain state, the customer is a member, etc.).

Examples of third parties that may use personal information verification may include health care facilities, financial institution in branch customer verification, money lending institutions (e.g., pay day lenders, loan issuing lenders, etc.), sellers of restricted items like alcohol or legal substances for pain management, etc.

In step 210, a customer may interact with the third party requiring customer personal information. For example, the interaction may require the customer's name, address, phone number, email address, date of birth, membership verification, etc.

In step 215, the customer may present a credential, such as a payment card (e.g., credit card, debit card), a payment token from a digital wallet, etc. to a third party terminal, such as a point of sale device, an online checkout, etc.

In step 220, the third party may communicate the credentials with a request for personal information or personal information verification to the trusted entity, such as financial institution.

In one embodiment, if the customer is conducting a transaction with the third party, the third party may leverage a payment network to combine the payment transaction and to request customer personal information or customer personal information verification in one call.

In step 225, using a PI verification computer program, the trusted entity backend may validate the request. For example, the trusted entity may validate the third party, the customer credentials, etc.

In step 230, the personal information identify verification computer program may verify that the third party was onboarded and may retrieve the configured personal information fields for the customer.

In step 235, the personal information identify verification computer program may determine an amount of customer personal information return to trusted entity. For example, the personal information identify verification computer program may determine to not provide any customer personal information to the third party if, for example, the customer has opted out of sharing personal information, if fraud is suspected, etc. The personal information identify verification computer program may also determine to provide less than the amount of customer personal information requested if the customer has only approved sending a portion of the customer personal information requested. For example, instead of releasing a date of birth, the customer may only authorize verification that the customer is over a certain age. As another example, instead of releasing a customer membership number, the customer may only authorize verifying that the customer is a member. The personal information identify verification computer program may also determine whether to provide the requested customer personal information to the third party.

In step 240, the personal information identify verification computer program may retrieve the customer personal information associated with the payment card.

In step 245, the personal information identify verification computer program may create payload including the customer personal information according to configured fields for trusted entity and the determined amount of customer personal information to provide.

In step 250, the personal information identify verification computer program may optionally provide the payload to the customer for approval to share the payload with the third party. In one embodiment, the personal information identify verification computer program may use an identity sharing notification system to request approval via email, SMS, in-app notification, etc.

If, in step 255, the customer approves sharing the payload with the third party (e.g., by an out of band message to the customer's electronic device, by a message that is displayed on the third party system, etc.), in step 260, the personal information identify verification computer program may provide the payload to the third party system.

If the customer does not approve of sharing the payload with the third party system, in step 265, the personal information identify verification computer program may return a rejection of the request to the third party system.

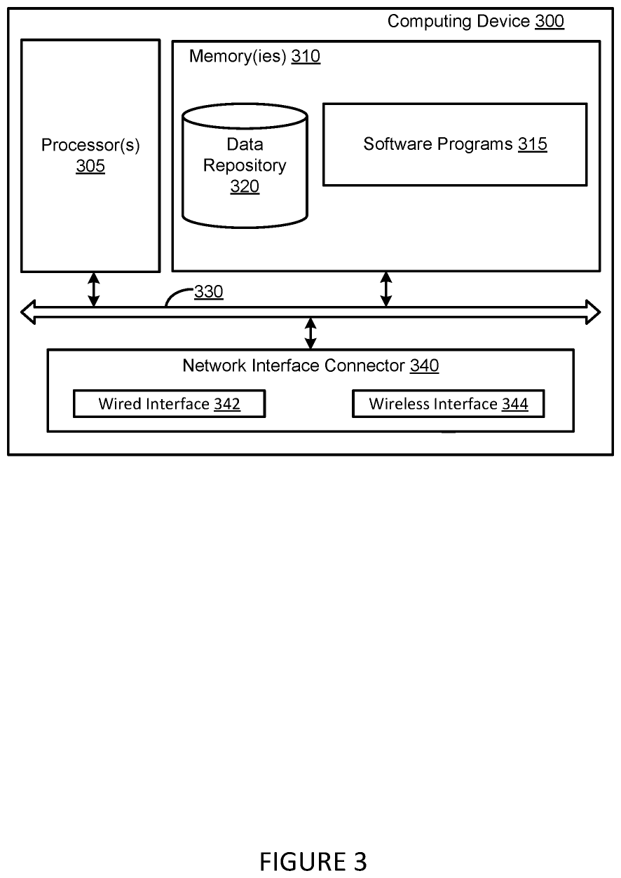

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for throttled sharing of personal information, comprising:
receiving, by a computer program at a trusted entity and from a customer, customer personal information;
receiving, by the computer program at the trusted entity and from a third party system, an identification of personal information fields required for a transaction;
receiving, by the computer program at the trusted entity and from the third party system, a request for personal information verification for a transaction involving the customer;
retrieving, by the computer program, the personal information fields required by the third party system;
creating, by the computer program, a payload comprising the customer personal information for the personal information fields required by the third party system; and
returning, by the computer program, the payload to the third party system.

2. The method of claim 1, further comprising:
determining, by the computer program, an amount of the customer personal information to return to the third party system, wherein the payload comprises the determined amount of the customer personal information.

3. The method of claim 1, further comprising:
providing, by the computer program, the payload to the customer; and
receiving, by the computer program, approval from the customer to provide the payload to the third party system;
wherein the approval is received before the payload is provided to the third party system.

4. The method of claim 1, wherein the customer personal information comprises a customer name, a customer address, a customer phone number, a customer date of birth, and/or customer memberships.

5. The method of claim 1, wherein the request for personal information verification comprises an identification of a payment card for the customer.

6. The method of claim 5, wherein the customer personal information is associated with the payment card.

7. The method of claim 4, wherein the personal information fields required comprise a subset of the customer personal information comprises a customer name, a customer address, a customer phone number, a customer date of birth, and/or customer memberships.

8. The method of claim 1, wherein the payload comprises a Boolean response.

9. A system, comprising:
a trusted entity executing a trusted entity computer program that is configured to receive, from a customer, customer personal information; and
a third party system that is configured to provide the trusted entity computer program with an identification of personal information fields required for a transaction and to request personal information verification from the trusted entity computer program for a transaction involving the customer;
wherein the trusted entity computer program is configured to retrieve the personal information fields required by the third party system in response to the request, to create a payload comprising the customer personal information for the personal information fields required by the third party system, and to return the payload to the third party system.

10. The system of claim 9, wherein the trusted entity computer program is further configured to determine an amount of the customer personal information to return to the third party system, and the payload comprises the determined amount of the customer personal information.

11. The system of claim 9, wherein the trusted entity computer program is further configured to provide the payload to the customer, to received approval from the customer to provide the payload to the third party system before providing the payload to the third party system.

12. The system of claim 9, wherein the customer personal information comprises a customer name, a customer address, a customer phone number, a customer date of birth, and/or customer memberships.

13. The system of claim 9, wherein the request for personal information verification comprises an identification of a payment card for the customer.

14. The system of claim 13, wherein the customer personal information is associated with the payment card.

15. The system of claim 13, wherein the personal information fields required comprise a subset of the customer personal information comprises a customer name, a customer address, a customer phone number, a customer date of birth, and/or customer memberships.

16. The system of claim 9, wherein the payload comprises a Boolean response.

17. A non-transitory computer readable storage medium, including instructions stored thereon, which when read and executed by one or more computer processors, cause the one or more computer processors to perform steps comprising:
receiving, from a customer, customer personal information, wherein the customer personal information comprises a customer name, a customer address, a customer phone number, a customer date of birth, and/or customer memberships;
receiving, from a third party system, an identification of personal information fields required for a transaction;
receiving, from the third party system, a request for personal information verification for a transaction involving the customer, wherein the request for personal information verification comprises an identification of a payment card for the customer;
retrieving the personal information fields required by the third party system;
determining an amount of the customer personal information to return to the third party system;
creating a payload comprising the determined amount of the customer personal information for the personal information fields required by the third party system; and
returning the payload to the third party system.

18. The non-transitory computer readable storage medium of claim 17, further including instructions stored thereon, which when read and executed by one or more computer processors, cause the one or more computer processors to perform steps comprising:
providing the payload to the customer; and
receiving approval from the customer to provide the payload to the third party system;
wherein the approval is received before the payload is provided to the third party system.

19. The non-transitory computer readable storage medium of claim 17, wherein the customer personal information is associated with the payment card.

20. The non-transitory computer readable storage medium of claim 17, wherein the personal information fields required comprise a subset of the customer personal information comprises a customer name, a customer address, a customer phone number, a customer date of birth, and/or customer memberships.
